(19) United States
(12) Patent Application Publication
(10) Pub. No.: US 2007/0172191 A1
(43) Pub. Date: Jul. 26, 2007

(54) Optical fiber treatment apparatus

(76) Inventor: Jae Seop Song, Daejeon (KR)

Correspondence Address: CANTOR COLBURN, LLP, 55 GRIFFIN ROAD SOUTH, BLOOMFIELD, CT, 06002, US

(21) Appl. No.: 10/589,477

(22) PCT Filed: Feb. 11, 2005
(86) PCT No.: PCT/KR05/00386

§ 371 Date: Aug. 14, 2006

(30) Foreign Application Priority Data
Feb. 13, 2004 (KR) 10-2004-0009448
Dec. 16, 2004 (KR) 10-2004-0107088

(51) Int. Cl. G02B 6/00

(52) U.S. Cl. 385/134

(57) ABSTRACT

The present invention relates to an optical fiber treatment apparatus and, more particularly, to an optical fiber treatment apparatus in which an outer cover of an optical fiber is peeled off by hot blast, and processes for peeling off an outer cover of a optical fiber, a cleaning and cutting of the optical fiber, and sleeving can be performed in sequence in order to connect cleaved optical-fibers and to make an optical-fiber device. In order to realize to the present invention, an outer cover peeling-off part is installed on a base, which holds an optical fiber with straight, and discharges a heated air to the straight held optical to remove the outer cover of the optical fiber by using a difference of thermal deformation between the inside outer cover and the outside outer cover. Further, a heater, a clamp means, a cutting means, a sleeve welding part and a control panel are installed on the same base in order to treat the optical fiber is in one apparatus.

### BACKGROUND OF THE INVENTION

(1) Field of the Invention

The present invention relates to an optical fiber treatment apparatus and, more particularly, to an optical fiber treatment apparatus in which an outer cover of an optical fiber is peeled off by hot blast, and processes for peeling off an outer cover of a optical fiber, a cleaning and cutting of the optical fiber, and sleeving can be performed in sequence in order to connect cleaved optical-fibers and to make an optical-fiber device.

(2) Description of the Related Arts

An optical fiber is a wave-guide for transmitting light and, in general, used in the form of a bundle of cable. The optical fiber is made of a synthetic resin, and in general, a glass having high transparency. The optical fiber is a double cylinder structure, and has a core and a cladding formed around the core. A synthetic resin encloses the cladding 2 or 3 times.

The optical fiber is very tolerant of electromagnetic interference, crosstalk and wiretap. The optical fiber is also small-sized and light weight to be robust against flexion, is strong against external environment and can contain numbers of communication lines therein to be used widely.

In order to fabricate an optical device or to couple optical fibers with each other, an optical fiber, which is enclosed by an outer cover in defined thickness, should be processed with a clean process and a cutting process.

In detail, there are conventional peeling-off methods for peeling off an outer cover. The methods are a contact method using a mechanical peeling device such as a stripper, a heating method for peeling off an outer cover by heating the outer cover through a heater, and a chemical method. The contact method would form a fine crack in a surface of optical fiber, in peeling of an outer cover, to produce a serious problem of reliability. In order to overcome the problem, a method for peeling off an outer cover by using a heater was proposed. In peeling-off of the outer cover of the optical fiber, the peeling-off is not constant due to the daily range, the seasonal temperature difference, and the humidity difference. In particular, as the physical property of the outer cover is different from maker to maker, the outer cover would not be removed perfectly, thereby welded to the optical fiber.

Further, after the peeling-off, a process for cleaning the optical fiber by means of alcohol and benzol, and a process for removing the remaining outer cover or the welded outer cover are subsequently performed, and finally, a process for cutting the cleaned optical fiber in a separate apparatus is performed to complete the processes.

However, in these kinds of processes, as each of the processes is performed in an individual apparatus and by manually, the processes are annoying to perform, and consumes lots of times. There is not any problem in case of small product, however, productivity is decreased in case of mass product.

### SUMMARY OF THE INVENTION

The present invention has been developed to solve the problems with above-described optical fiber treatment apparatus.

It is an object of the present invention to provide an optical fiber treatment apparatus in which an outer cover of an optical fiber can be peeled off clearly by a heated air irrespective of a property difference of outer cover by makers, or an external conditions such as temperature and humidity, a cutting process can be performed without an additional cleaning process due to the perfect peeling-off, and successive processes for fitting a sleeve in an optical fiber, which is welded by a separate device, and heating and welding the sleeve and making a device can be performed in one apparatus in sequence.

In order to achieve the objects, the present invention has characteristic structures as described below.

An outer cover peeling-off part is installed on a base, which holds an optical fiber with straight, and discharges a heated air to the straight held optical to remove the outer cover of the optical fiber by using a difference of thermal deformation between the inside outer cover and the outside outer cover. The temperature for the heated air is set to 400° C.˜500° C.

The outer cover peeling-off part includes a heater, installed on the base, for heating air injected from outside to discharge the heated air to the outside; and a clamp means, installed on the base, for clamping both side of the optical fiber at a point for the heated air discharged by the heater to remove the outer cover by means of the heated air from the heater.

At this time, the heater includes a housing having a hollow body, one end of the hollow body connected to a nozzle for discharging air, and the other end of the hollow body connected with a closing body for closing the hollow body; a blastpipe connected in the housing and having a passage for passing air injected through the closing body to the nozzle; and a heating body installed in the blastpipe, said heating body being heated by electric power from outside to heat the injected air.

In here, the heating body is preferably any one of a coil type heating body formed by winding a heating line as a coil-shape and a ceramic heating body formed as a ceramic rod.

In here, the coil type heating body is formed by bending the heating line to have 3 and more angles, said heating body being shown as a twisted shape. The heater is slightly inclined to discharge the heated air downwardly.

The clamp means includes a sliding guide, said sliding guide having a straight line in front of the heated air discharging opening of the heater. the clamp means comprises a clamp bundle connected on an axis of the sliding guide to perform selectively a straight movement and a rotational movement; a finger base having a receiving groove for positioning the optical fiber on the lower side of the clamp bundle; a finger connected by a hinge and for clamping the optical fiber in the receiving groove on the upper side of the finger base; a torsion spring elastically connected the hinge to apply always elasticity in a direction for unclamping the finger; and a finger operating lever rotatably connected the finger base in the rear of the finger to clamp the finger through a rotation operation.

The clamp means comprises a rotation preventing axis for connecting the clamp bundles to prevent an individual movement of clamp bundle, and the clamp means further comprises a tension controlling means for adjusting a tension of the clamped optical fiber by moving the tension controlling means centering around an axis of an fixing axis by a clearance in the equally divided clamp bundles.

The tension controlling means comprises a ball bearing positioned with a point contact between the outer diameter of the fixing axis and the inner diameter of the clamp bundles to guide a rotational movement, or the rotational movement and a straight movement; a big diameter and a small diameter ring bushes connected slidably with each other and positioned between the inner diameter of each one end of the clamp bundles and the outer diameter of the fixing axis with a slack; a elastic member elastically connected in the inner side of each of the clamp bundles between the ring bushes to push the clamp bundles at all times; a tension applying pusher coupled slidably on the fixing axis from a tip end of the fixing axis to a tip end of the clamp bundle; and a cam lever rotatably connected to an end of the fixing axis, and having a curved cam line to move the tension applying pusher with a predetermined clearance according to a rotation of the fixing axis and to supply an operational power to the elastic member.

The present invention further includes a cutting means, positioned on the base at a side of the outer cover peeling-off part, for clamping the optical fiber and for cutting the clamped optical fiber.

The cutting means comprises a body having a straight guiding groove perpendicular to the sliding guide and installed on a side of base 10, the side being not faced to the heater and included in a straight section of the clamp means; a slider connected in the straight guiding groove of the body; a slider controlling means provided to both of the body and the slider to control a forward and backward movement of the slider to make it possible to scratch the optical fiber when the clamp means in a cutting position, and to maintain the backward movement of the slider for cutting the optical fiber; a cutter, mounted on the slider having the slider controlling means, for scratching a circumference of the optical fiber along a movement of the slider; a press means operated in the direction of rotating axis on the optical fiber scratched by the cutter to cut the scratched portion of the optical fiber; and a cover rotatably connected to a side of the body and pivoted on the hinge to control the forward and backward movement of the slider, and to control the rise and fall of the press means in connection with the forward and backward movement of the slider.

The slider controlling means comprises an elastic member positioned between the slider and the straight guiding groove to provide a forward force to the slider; a pusher formed at the rear of the cover to operate in connection with an opening of the cover, and to overcome elasticity of the elastic member to back the slider; a lower stopper elastically supported by a elastic member in vertical direction on the slider to obtain a climbing power in order to maintain the slider backed by the pusher or to move the slider forward; an upper stopper, operated in connection with a closing motion of the cover, for controlling the lower stopper to provide a forward force to the slider; and a protrusion, formed on a side of the slider, for falling the press means after the optical fiber being scratched by an operation of the lower and upper stoppers together with the forward movement of the slider.

Further, the press means comprises a plunger positioned under the cover opposite to the cutter moved forward and backward, and risen and fallen by an elastic member; and a plunger stopper protruded downwardly from a side of the plunger and supported by the protrusion of the slider, the plunger stopper stroking and cutting a scratched portion of the optical fiber as a supporting of the protrusion being released after the optical fiber scratched by a forward movement of the slider and the cutter.

In addition, the cutting means is an ultrasonic cutter, and the ultra sonic cutter cuts an optical fiber with a removed outer cover when the optical fiber with the outer cover removed by the outer cover peeling-off part is mounted.

The ultrasonic cutter comprises a body mounted on the base to be straight to the clamp means, the body having a slidably connected guide axis, the guide axis being moved in straight in parallel to a length direction of the clamped optical fiber; a sliding body slidably connected to move forward and backward with respect to the clamped optical fiber on the upper part of the body, and having a stopper for limiting the forward and backward movement to the body in the rear; a damper installed at the rear of the body to interfere with the stopper at all times, and providing a reduced forward moving force to the sliding body through a spring pushing the sliding body and a piston generating an air resistance; a cutting lever rotated by a rotating axis at the front of the body, and providing a reduced backward moving force to the sliding body by overcoming the damper by means of an interfering protrusion projected from the sliding body in a rotating position; and a cutter installed on the upper part of the sliding body to be operated with the operation of the damper and the cutting lever, and cutting the optical fiber by using a vibration from an ultrasonic oscillator.

Further, the present invention also comprises an exhaust pipe, in the base, for removing and discharging a smoke or a stench produced by the peeling-off of the outer cover from the heater, and an exhaust fan connected to the exhaust pipe.

In addition, the present invention includes a sleeve welding part for inserting a sleeve in an optical fiber and welding the sleeve is installed on the base, the optical fiber being performed with a peeling-off of outer cover, a cutting by a cutter and a welding by a separate welder.

The sleeve welding part comprises a heating room connected to a passage for a heated air, and a door for opening/closing the heating room when an optical fiber with a shrinking sleeve being positioned in the heating room.

The sleeve welding part further comprises a sleeve heater in the heating room to shorten the heating time of the shrinking sleeve. In other example, the sleeve welding part also comprises a heating room with a door for opening/closing the inner space of the room in the base, and a sleeve heater for heating an optical fiber with a shrinking sleeve in the inner space and welding the sleeve.

In another example, the sleeve welding part comprises another heater for peeling off the outer cover in addition to the heater for discharging a heated air, a heating room connected to a section for discharging the air heated by the another heater, and a door for opening/closing the heating room when an optical fiber with a shrinking sleeve being positioned in the heating room.

In addition, the present invention comprises a control panel for turning on/off electric power, controlling a heating temperature gradually, and controlling processes for peeling-off of outer cover, cutting and sleeve welding.

The control panel comprises a key pad for inputting requirements for turning on/off electric power, setting of heating temperature and processes for peeling-off of outer cover and welding of cut sleeve; a temperature sensing part, installed on a side of a space, for sensing air heated by the heater or the sleeve heater in the space; a control part for receiving the temperature signal sensed by the temperature sensing part in real time, and controlling an operation of the heater or the sleeve heater and an operation of a driver for moving a cutting means when a difference between the sensed temperature and the set up temperature being sensed; and the driver for driving the cutting means for moving the heater, the sleeve heater and the cutting means through a signal from the control part.

The control part comprises a data part for storing a temperature data for the outer cover of optical fiber and the shrinking sleeve in order to drive the heater or the sleeve heater based on working temperature according to the kind of outer cover of the optical fiber or the shrinking sleeve.

The present invention comprises a driving part for moving the heater horizontally or vertically in order to oppose a heated air discharging section to an outer cover removing section in a moment to remove the outer cover.

In another example, the present invention comprises a driving part, in the base, for moving an optical fiber with straight or rotating the optical fiber in order to oppose a heated air discharging section to an outer cover removing section in a moment to remove the outer cover.

Further the present invention is structured such that a length of a heated air discharging section is formed to be equal to that of au outer cover removing section to peel of an outer cover of optical fiber in a process for opposing the heated air discharging section to the outer cover removing section.

In another example, the present invention is structured such that a heated air discharging section is formed to shortened than that of an outer cover removing section to peel off an outer cover of optical fiber by moving the heated air discharging section along the outer cover removing section, or moving the optical fiber with respect to the heated air discharging section by the outer cover removing section.

The heater comprises a heater, installed on the base, for heating air injected from outside to discharge the heated air to the outside; a heating body connected in the housing to heat an injected air through electric power form an outside power supply; and a passage forming pipe connected between the housing and the heating body to go and return air injected through a closing body from the inner circumference of the housing and the heating body two time and more, and to discharge the air to the nozzle.

### BRIEF DESCRIPTION OF THE DRAWINGS

The above objects, other features and advantages of the present invention will become more apparent by describing the preferred embodiment thereof with reference to the accompanying drawings, in which:

FIG. 1 is a plan view showing an optical fiber treatment apparatus according to a first embodiment of the present invention.

FIG. 2 is a cross-sectional view taken along line A in FIG. 1, showing a clamp means according to the present invention.

FIG. 3 is an enlarged view of important element in FIG. 2.

FIGS. 4-6 are a cross-sectional view taken along line B in FIG. 1, showing a cutting means.

FIG. 7 is a plan view of a second embodiment of an optical fiber treatment apparatus according to the present invention.

FIG. 8 is a enlarged plan view showing a clamp means in FIG. 7.

FIGS. 9 and 10 are a cross-sectional view taken along line C-C in FIG. 7, showing a tension controlling means according to the present invention.

FIG. 11 is a cross-sectional view taken along line D-D in FIG. 7.

FIGS. 12-14 are a view showing a peeling-off of an outer cover of an optical fiber.

FIG. 15 is a cross-sectional view showing a further embodiment 1 according to the present invention.

FIG. 16 is an enlarged front view of an important element in FIG. 15.

FIG. 17 is a cross-sectional view showing a further embodiment 2 according to the present invention.

FIG. 18 is a block diagram of a further embodiment 3 according to the present invention.

FIGS. 19 and 20 are a conceptual view of a further embodiment 4 according to the present invention.

FIGS. 21 and 22 are a conceptual view of a further embodiment 5 according to the present invention.

FIGS. 23 and 24 are a conceptual view of a further embodiment 6 according to the present invention.

FIG. 25 is a cross-sectional view of a further embodiment 7 according to the present invention.

### DETAILED DESCRIPTION OF THE EMBODIMENTS

Referring now to attaching the drawings, an optical fiber treatment apparatus according to embodiments of the present invention will be described in detail. It is noted that like parts are designated by like reference numerals throughout the accompanying drawings.

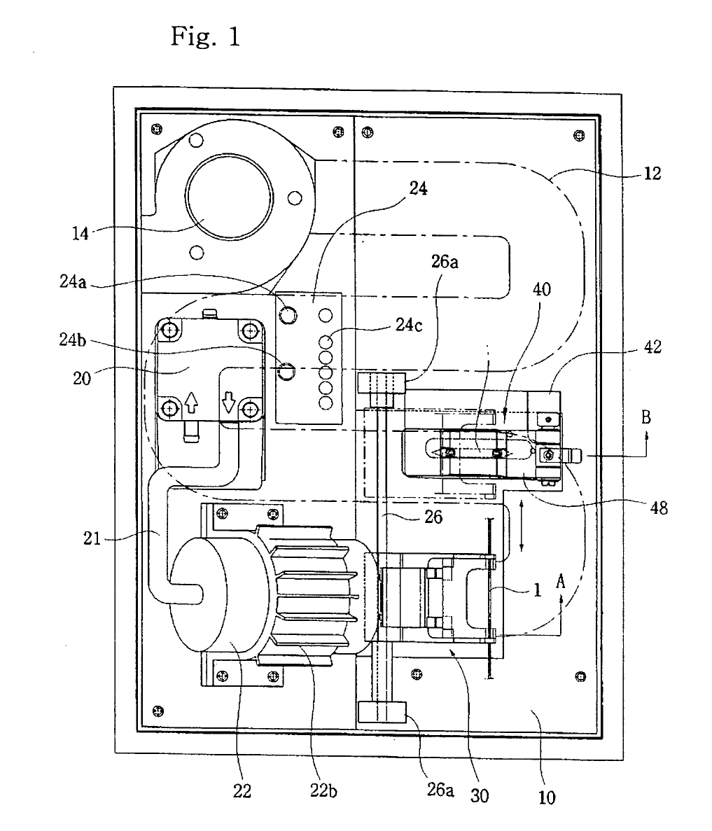

FIG. 1 shows a plan figure of an optical fiber treatment apparatus according to the first embodiment of the present invention, in which a process for peeling off an outer cover of optical fiber 1, a process for totally blowing off the outer cover by using a blowing and a process for cutting the optical fiber are performed.

The optical fiber treatment apparatus according to the present invention has a plane base 10 for mounting elements for the present invention thereon. An air generator, a compressor, is installed on one side of the base 10.

A heater 22, which is connected to a supplying hose 21 for supplying with an air and has a heated-air discharging opening 22a, is provided a place adjacent to the air generator 20, in which an air is pre-heated and sent through a narrow passage to the discharging opening. It is preferably to provide an outside of case of the heater 22 with a radiating pin 22b.

In here, the temperature of a heated-air discharged from the heater 22 is set to 400° C.-500° C. As the temperature depends on an outer cover of optical fiber by makers, the temperature is set to the highest and lowest temperature for removing the outer cover.

Meanwhile, a control panel 24 for controlling the heater 22 and operating of the apparatus is mounted on the base 10 adjacent to the heater 22. Installed on the control panel 24 are a power switch 24a for turning on/off power, a temperature controlling button 24b capable of increasing a heating temperature gradually in order to prevent the outer cover from being burned and stuck to the optical fiber by adjusting the heating temperature according to the physical property of the outer cover and other conditions, and a temperature displaying LED 24c for displaying a gradually increased temperature.

Further, a sliding guide 26 is provided to a position adjacent to the heated-air discharging opening 22a of the heater 22, which is a straight section and is fixed with a bracket 26a to ensure a straight movement of clamp means 30 which will be described later.

The clamp means 30 is connected on the equally divided sliding guide 26 to enable a straight movement and rotation movement of the clamp means with simultaneous or with selective. In the clamp means, an outer cover of an optical fiber is removed by clamping the optical fiber in length direction and inserting the fiber into the heated-air discharging opening 22a.

A detailed embodiment of the clamp means 30 will be described later.

In here, the heater 22 and the clamp means 30 are essential means for peeling off and removing the outer cover of the optical fiber, and forms a outer cover peeling-off part.

Finally, a cutting means 40 is installed on a side of the base 10, which is not faced to the heater 22 but included in the straight section of the clamp means 30, to perform a scratching and cutting of a clamped optical fiber with continuous by moving the clamp means 30 on the sliding guided 26. A detailed embodiment of the cutting means 40 will be described later.

Meanwhile, an exhaust pipe 12 for discharging a smoke or stench, which is produced in the peeling off and removing of the outer cover, and an exhaust fan 14 connected to the exhaust pipe 12 are further provided in the base 10.

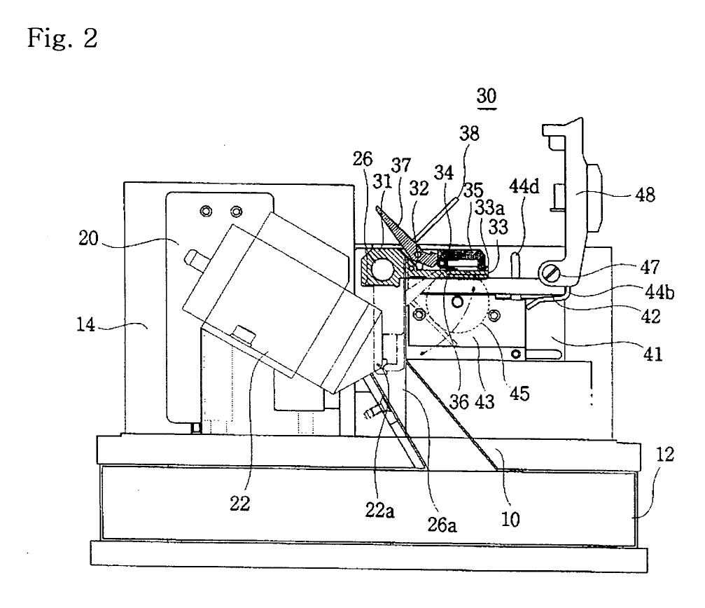

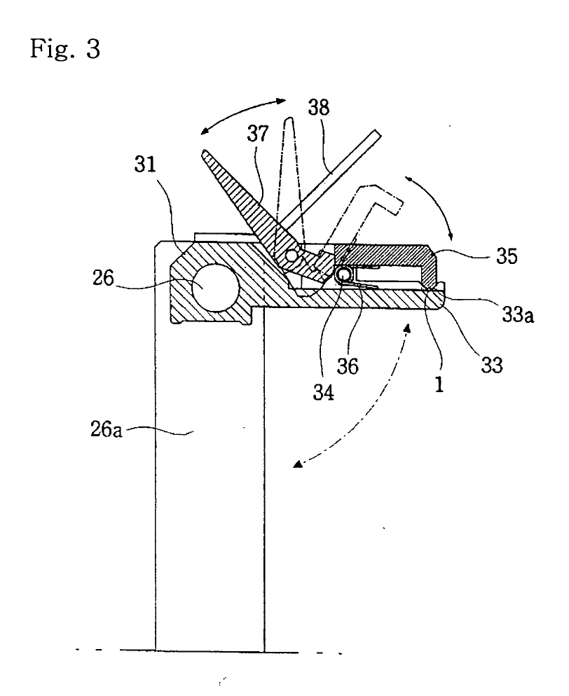

First, as will be seen from the FIG. 2 and FIG. 3, the clamping means 30 in an embodiment of the optical fiber treatment apparatus according to the present invention includes a clamp bundle 31 capable of performing a straight movement and a rotational movement with simultaneous or concurrent on the sliding guide 26, a finger base 33 having a receiving groove 33a for receiving an optical fiber in a lower part of the clamp bundle 31, a finger 35 connected with a hinge 34 to clamp the optical fiber in the receiving groove 33 on a upper part of the finger base 33, a torsion spring 36 pivoted on to the hinge 34 applying elasticity to always unclamp the finger 35, and a finger operating lever 37 connected to the finger base in the rear of the finger 35 and clamping the finger 35 by rotating.

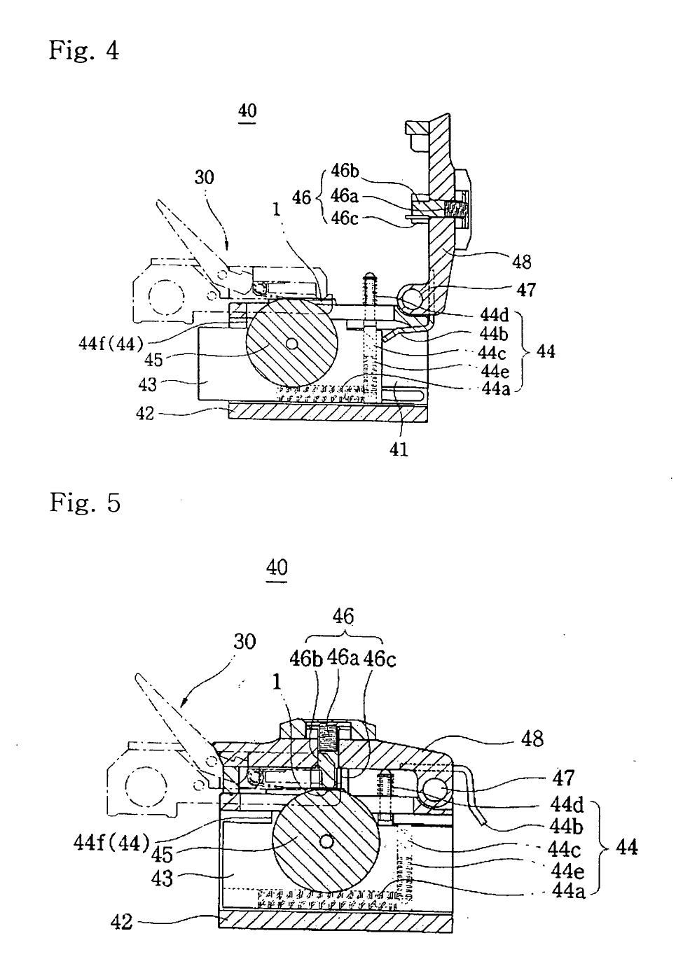

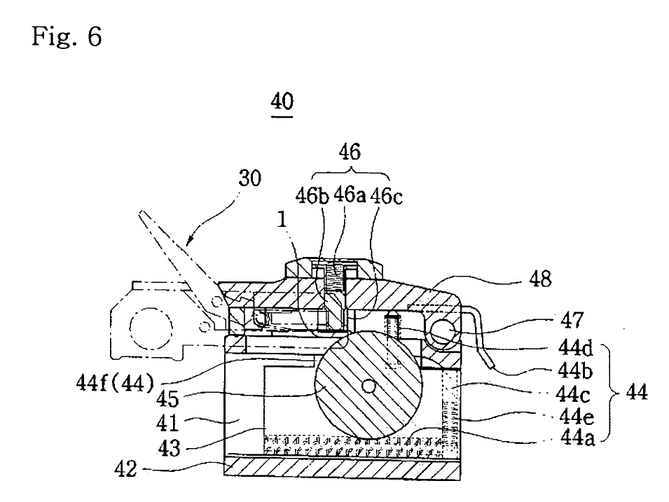

Next, as shown in FIG. 4-FIG. 6, the cutting means 40 is installed on a side of the base 10 which is not faced to the heater 22 and is include in the straight section of the clamp means 30. The cutting means includes a body 42 having a straight-guiding groove 41 perpendicular to the sliding guided 26; a slider 43 connected in the straight-guiding groove 41 of the body 42; a slider controlling means 44 provided to both of the body 41 and the slider 43 to control a forward and backward movement of the slider 43 to make it possible to scratch an optical fiber when the clamp means 30 in the cutting position, and to maintain the backward movement of the slider 43 for cutting the optical fiber; a cutter, mounted on the slider 43 having the slider controlling means 44, for scratching circumference of the optical fiber along a movement of the slider; a press means 46 operated in the direction of rotating axis on the optical fiber scratched by the cutter 45 to cut the scratched portion of the optical fiber; and a cover 48 connected to a side of the body and pivoted on the hinge 47 to control the forward and backward movement of the slider 43, and to control the rise and fall of the press means 46 in connection with the forward and backward movement of the slider 43.

Next, an embodiment of the slider controlling means 44 and the press means will be described in detail.

The slider controlling means 44 according to the present invention includes an elastic member 44a positioned between the slider 43 and the straight-guiding groove 41 to provide a forward force to the slider 43; a pusher 44b formed at the rear of the cover to operate in connection with an opening of the cover 48, and to overcome elasticity of the elastic member 44a to back the slider; a lower stopper 44c elastically supported by a elastic member 44d in vertical direction on the slider 43 to obtain a climbing power so as to maintain the slider 43 backed by the pusher 44b or to move the slider forward; an upper stopper 44e, operated in connection with a closing motion of the cover 48, for controlling the lower stopper 44c to provide a forward force to the slider 43; and a protrusion 44f, formed on a side of the slider, for falling the press means 46 after the optical fiber is scratched by the operation of the lower and upper stoppers 44c and 44e together with the forward movement of the slider 43.

Next, an embodiment of the press means 46 will be described in detail.

The press means 46 according to the present invention includes a plunger 46b positioned under the cover 48 opposite to the cutter 45 moved forward and backward, and risen and fallen by an elastic member 46b; and a plunger stopper 46c protruded downwardly from a side of the plunger 46b and supported by the protrusion 44f of the slider 43. The plunger stopper strokes and cuts a scratched portion of the optical fiber as a supporting of the protrusion 44f is released after the optical fiber is scratched by a forward movement of the slider 43 and the cutter 45.

Next, the second embodiment of the optical fiber treatment apparatus according to the present invention will be described.

The structure of this optical fiber treatment apparatus is the same as that of the above-described one embodiment excepting a clamping means 300 and a cutting means 400.

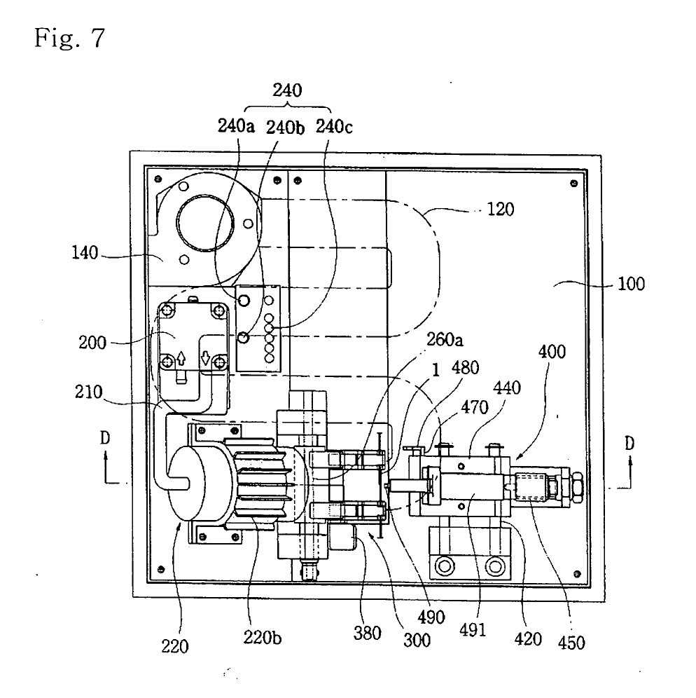

That is, as shown in FIG. 7, an air generator 200, installed on a base 100, for generating a compressed air; a heater 220 supplied with an air though a supplying hose 210 from the air generator 100, and having a heated-air discharging opening 200a, which is pre-heated and discharges a heated air from an upper part to a lower part, and a radiating pin 220b; and a control panel provided with a power switch 240a for turning on/off power; a temperature controlling button 240b for increasing a heating temperature gradually, and a temperature displaying LED 240c for a controlling of temperature are the same as those of the above-described one embodiment.

But, a clamp means 300 which is positioned on a place facing toward the heater 220, and clamps an optical fiber in length direction and inserts the optical fiber into the heated-air discharging opening 220a in a moment to remove an outer cover of the optical fiber, in which numbers of equally divided clamp members are connected together on a fixing axis 260 to rotate freely; and a cutting means 400 which is positioned on a portion of base 100 facing toward the clamp means 300, and cuts the optical fiber, with the outer cover removed, by using an ultrasonic cutting method from an opposite direction of length are different from those of the above-described one embodiment.

That is, a structure for the ultrasonic cutting method for cutting an optical fiber with an outer cover removed constitutes an ultrasonic generating part. A structure for the ultrasonic generating part will be described in detail below.

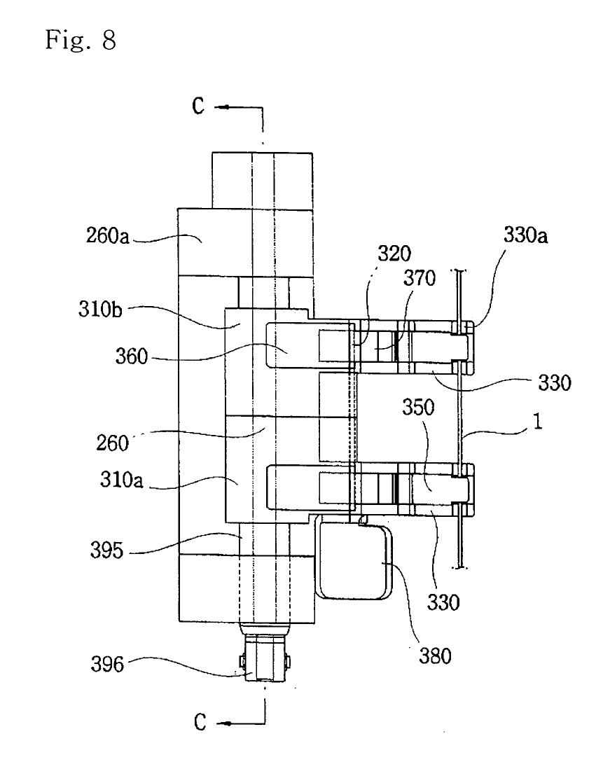

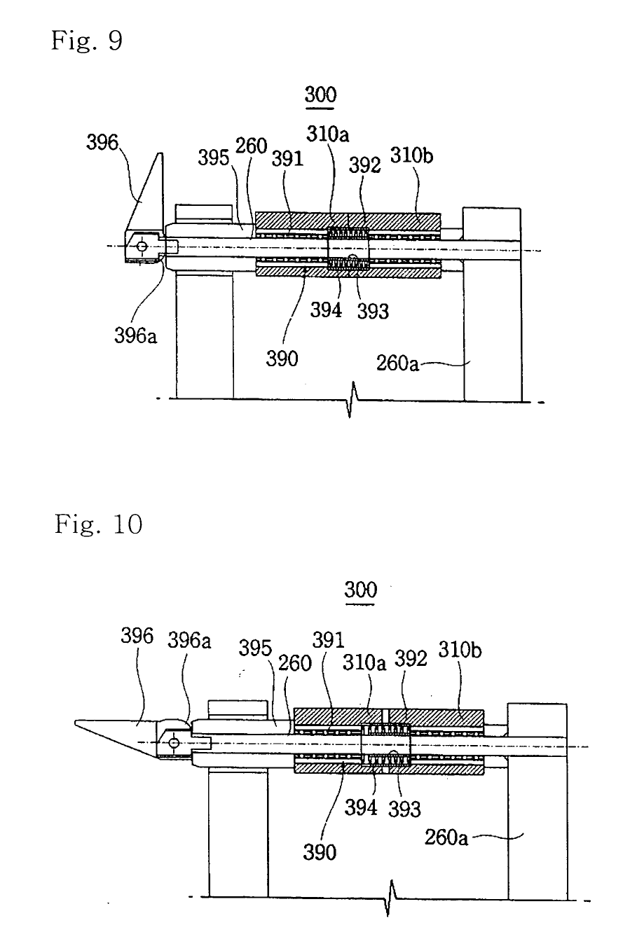

As shown in FIG. 8, FIG. 9 and FIG. 10, the clamp means 300 comprises a pair of clamp bundle 310a and 310b which is equally divided and positioned in parallel to be connected to a fixing axis 260; a rotation preventing axis which connects the clamp bundles 310a and 310b to prevent an individual movement of the bundles; a finger base 330 having a receiving groove 330a for positioning an optical fiber on lower parts of the clamp bundles 310a and 310b; a finger 350 connected to a hinge 340 to clamp the optical fiber in the receiving groove 330a on a upper part of the finger base 330; a torsion spring 360 which is elastically connected to the hinge 340 to produce elasticity in the direction that the finger 350 is unclamped; a finger-operating lever 370, rotatably connected the finger base 330 in the rear of the finger 350, for clamping the finger 350 through a rotating operation; and a tension controlling means 390 which adjusts the tension of the clamped optical fiber by moving the tension controlling means centering around the axis of the fixing axis 260 by a clearance in the equally divided clamp bundles 310a and 310b.

Further, as shown in FIGS. 9 and 10, the tension controlling means 300 comprises a ball bearing 391 which is positioned with a point contact between the outer diameter of the fixing axis 260 and the inner diameter of the clamp bundles 310a and 310b) to perform a straight movement and a rotational movement with selective or at the same time; a big diameter and a small diameter ring bushes 392 and 393 which are connected with each other and positioned between the inner diameter of each one end of the clamp bundles 310a and 310b and the outer diameter of the fixing axis 260 with a slack; a elastic member 394 which is elastically connected in the inner side of each of the clamp bundles 310a and 310b between the ring bushes 392 and 393 to push the clamp bundles 310a and 310b at all times; a tension applying pusher 395 which is coupled on the fixing axis 260 from a tip end of the fixing axis 260 to a tip end of the clamp bundle 310a; and a cam lever 396 which is rotatably connected to an end of the fixing axis 260 and has a curved cam line to move the tension applying pusher 395 with a predetermined clearance according to a rotation of the fixing axis and to supply an operational power to the elastic member 394.

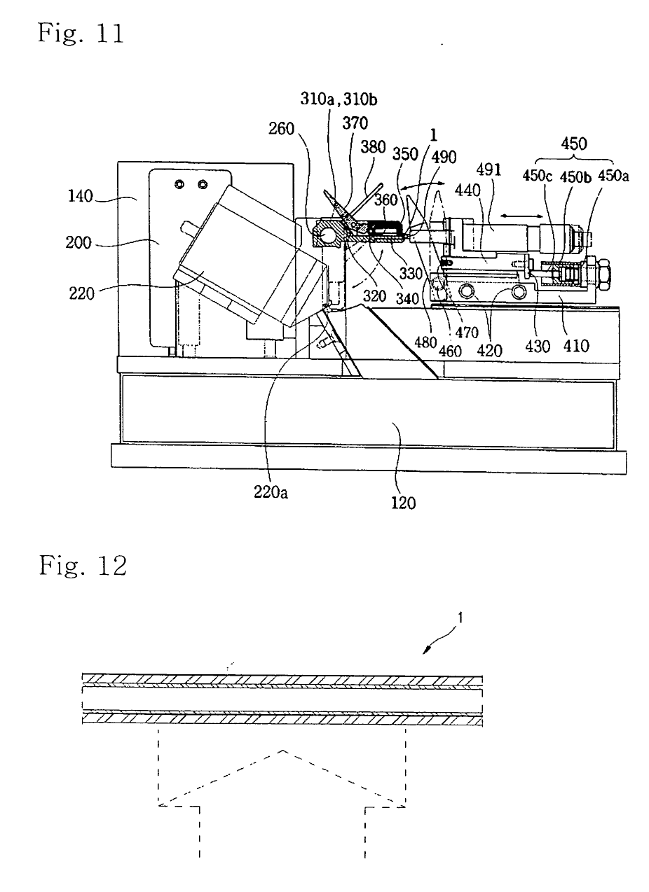

As shown in FIG. 11, the cutting means 400 includes the heater 100; a body 410 which is mounted on the base 100 to be straight to the clamp means 300, and has a slidably connected guide axis 420, the guide axis being moved in straight parallel to the length direction of the clamped optical fiber 1; a sliding body 440 which is slidably connected to move forward and backward with respect to the clamped optical fiber 1 on the upper part of the body and has a stopper 430 for limiting the forward and backward movement to the body 410 in the rear; a damper 450 which is installed at the rear of the body to interfere with the stopper 430 at all times, and provides a reduced forward moving force to the sliding body 440 through a spring 450a pushing the sliding body 440, and a piston 450b generating the air resistance and a piston rod 450c; a cutting lever 480 which is rotated by the rotating axis 460 at the front of the body, and provides a reduced backward moving force to the sliding body 440 by overcoming the damper 450 by means of an interfering protrusion 470 projected from the sliding body 440 in a rotating position when rotated manually; and a cutter 490 which is installed on the upper part of the sliding body 440 to be operated with the operation of the damper 450 and the cutting lever 480, and cuts the optical fiber by using the vibration from an ultrasonic oscillator 491.

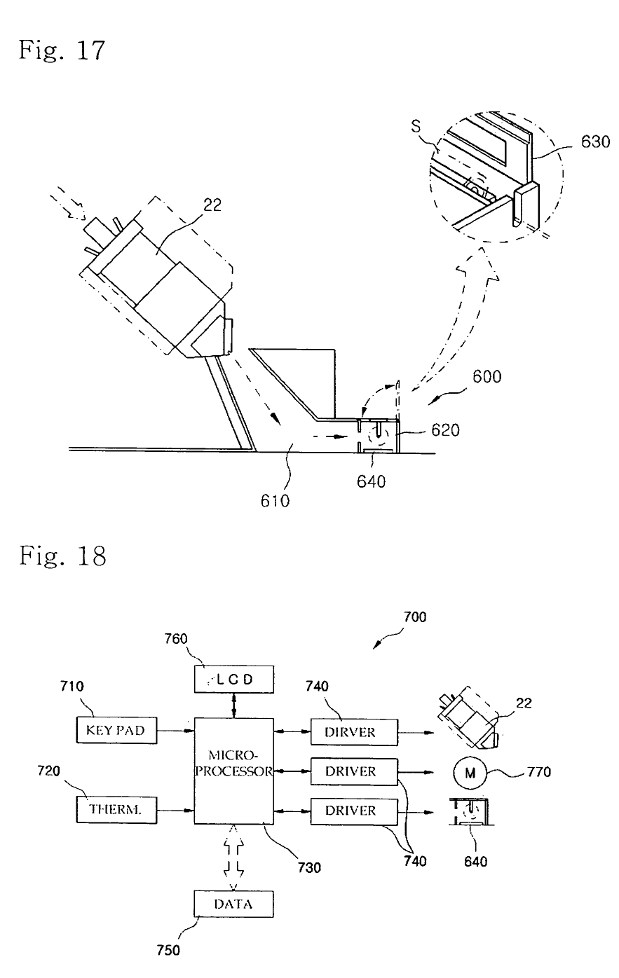

In here, it is possible to construct that the cutting lever 480 for moving the cutter 490 is driven by a motor (Ref. No 770 in FIG. 17) to cut an optical fiber automatically.

An exhaust pipe 120 and an exhaust pan 140 can be provided in the second embodiment.

Meanwhile, although not shown in Figs., the air generator and the heater in the first and second embodiments can be embodied in various ways. That is, the air generator can be substituted with a blow fan using a natural air, and the heater can be substituted with a gas burner type heating means.

From now, the operation of the embodiments according to the present invention will be described below.

In the first embodiment, the optical fiber 1 is first positioned in the receiving groove 33a of the finger base 33 before operating of the optical fiber treatment apparatus according to the present invention. After this, the finger-operating lever 37 is pushed to interfere with the finger 35 and to overcome the elasticity of the torsion spring 36. Then, a clamping state of the finger 35 is set.

Next, the clamp means 30 is slidably moved through the sliding guide 26 to the heater 22 to ready operation. The clamp bundle 31 of the clamp means 30 has a bearing to perform a straight movement and a rotational movement with respect to the sliding guide 26 with selective or at the same time.

Meanwhile, at the operation, a power switch 24a in the control panel 24 is pushed to provide electrical power with the air generator 20 and the heater 22. A compressed air from the air generator 20 is passed through the supplying hose 22a to the heater 22, and the heater heats the compressed air to discharge the heated air through the heated-air discharging opening 22. At this time, a clamp rotating lever 38 is pressed down by an operator and the clamped optical fiber is exposed to the heated air in an instant at the heated-air discharging opening 22a.

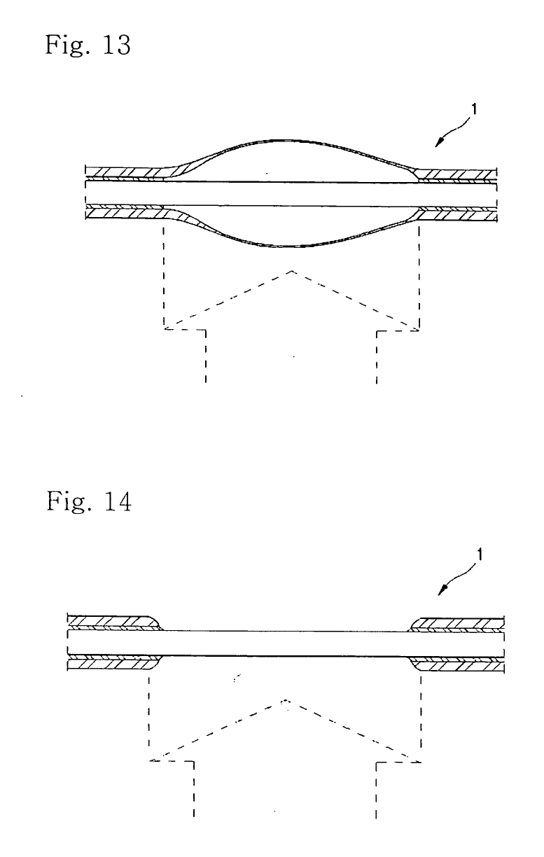

By this instant operation, an inside outer cover of the optical fiber exposed to the heated air, shown in FIG. 12, is received with a high temperature to be changed to gaseous state, shown in FIG. 13. Thus, the space in the inside outer cover is expanded to expand an outside outer cover.

Then, the expanded outer cover is, as shown in FIG. 14, pushed and peeled off by the heated air from the heater. As the direction of the heated air is blown from the lower part to the upper part in the figure, the outer cover is removed clearly.

In addition, as the physical property of the outer cover is different from maker to maker and a condition for operation is different from site to site, the temperature for heating the air needs to be varied. Without this condition, the outer cover may be attached to the optical fiber. In the present invention, the temperature can be gradually adjusted by the temperature controlling button 24b and the temperature displaying LED 24c. Further, the temperature can be adjusted quickly and easily as the temperature is displayed through the LED.

Further, the exhaust pipe 12 and the exhaust pan 14 are installed in the present invention to remove a smoke and stench produced by the peeling of the outer cover continuously and to improve environment of the working place.

In addition, after the peeling off and removing (cleaning) processes, the clamp means 30 is returned through the sliding guide 26 to its original state (a level state) to ready a process for cutting another optical fiber. That is, another optical fiber clamped by the clamp means 30 is positioned on the cutter 45 of the cutting means 40.

After this, the process for cutting the optical fiber is started. As shown in FIG. 4-FIG. 6, the cover 48 overcomes the elasticity of the elastic member 44a of the upper stopper 44e to lift down the lower stopper 44c as the cover 48 is pressed. The upper stopper 44e also overcomes the elasticity of the elastic member 44d to lift down the lower stopper 44c. Therefore, the slider 43 is moved forward by the elasticity of the elastic member 44a, and the cutter 45 installed on the slider 43 scratches the optical fiber. At this moment, the plunger stopper 46c is supported by the protrusion 44f to hold its lifted-up state.

In the lifted-up state of the plunger 46c, the plunger stopper 46c is not supported by the protrusion 44f the slider anymore as the slider 43 is advanced in a moment. Therefore, the plunger stopper 46c and the plunger 46b are lifted down by the elasticity of the elastic member 46a in an instant. With the lifting down of the plunger 46, the scratched optical fiber 1 is cut wholly. Thus, the first process for peeling off, cleaning and cutting the outré cover is completed.

An operation of another embodiment of the optical fiber treatment apparatus according to the present invention is similar in many aspects.

That is to say, the processes for clamping the optical fiber 1 in the receiving groove 330a of the finger base 330 of the clamp means 300, applying electrical power through the control panel 240 (a power switch 240a), supplying air from the air generator 200 to the heater 220, controlling a temperature (a temperature controlling button 240b) and discharging a heated air from the heated-air discharging opening 220a are similar to those of the first embodiment.

Further, pressing a rotating lever 380 of the clamp means 300 and approaching the optical fiber the heated air in a moment, removing the optical fiber from the heated air just after peeling off the outer cover, removing a smoke and stench caused by the peeling-off of the outer cover through a exhaust pipe 120 and the exhaust pan 140 are similar to those of the first embodiment.

In the process for preparing the cutting after peeling off the outer cover of the optical fiber, moving the clamp means 300 is different from the first embodiment. In this embodiment, the clamp means 300 is approached to the cutting step by only a rotating operation as the heater 220, the clamp means 300 and the cutting means 400 are in the same straight line.

In addition, the optical fiber 1 with the outer cover removed undergoes a cutting process. Constant tension is applied to the optical fiber before the cutting process in order to make a good cut plan as the cutting method is by an ultrasonic cutting.

That is, as shown in FIGS. 9 and 10, when the cam lever 396 fixed to the tip end of the fixing axis 260 is rotated from the vertical state to the level state, the equally divided clamp bundles 310a and 310b are guided in the big and small diameter ring bushes 392 and 393 by the curved cam line 396a and the elasticity of the elastic member 394 to push the tension applying pusher 396 to the outer direction and to make a constant slack. At this time, constant tension is applied to the optical fiber due to a pulling force applied to both sides of the optical fiber.

Then, the cutting process is started. First, when rotating the cutting lever 480 connected rotatably to the tip end of the body 410 to the clamp means 300 after the ultrasonic oscillator 491 is started to operate the cutter 490, the interfering protrusion 470 on the sliding body 440 in interfered state by the lever is released and the spring 450a of the damper 450 at the rear of the body 440 is expanded to advance the piston 450b and the piston rod 450 slowly due to an air resistance. The advance force by the piston and the piston rod makes the sliding body slidably connected to the body 410 and the cutter 470 of tip end of the ultrasonic oscillator 491 fixed on the upper side of the sliding body 440 reach to and cut the circumference of the optical fiber through the inference state between the piston rod 450c and the stopper 430. Thus, the first process of the second embodiment for cutting, cleaning and cutting the optical fiber is completed.

### FURTHER EMBODIMENT 1

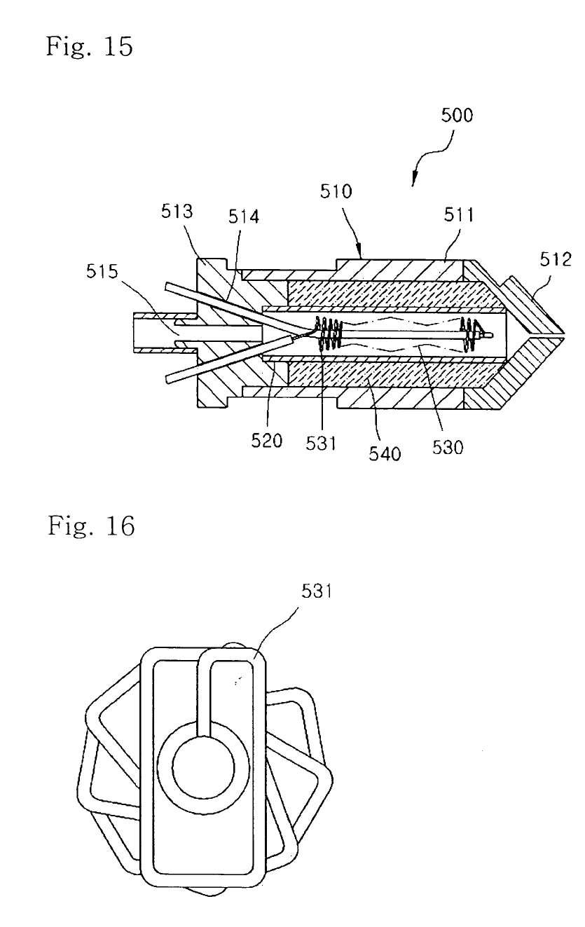

FIG. 15 is a cross-sectional view of further embodiment according to the present invention. FIG. 16 is an enlarged front view of important parts in FIG. 15. The figure illustrates the heart in the first and second embodiments in detail

Referring to figure, a heater 500 in the further embodiment comprises a housing 510, blastpipe 520 and a heating body 530.

In the housing, a nozzle 512 for discharging air is connected to one end of a hollow body 511 and a closing body 513 for closing the body 511 is connected to the other end of the body. A sharpened point is formed in the tip end of the nozzle 512, and a nozzle opening for discharging air is formed in the sharpened point.

Further, the closing body 513 is formed with a passing-through hole 514 for passing the heating body 530 from the outside to the inside of the housing 510. An air passage 515 is also formed in the closing body and connected to the blastpipe 520 to supply air from the outside (the air generator in the first and second embodiments) to the inside of the housing.

The blastpipe 520 is connected in the housing 510 and the hollow body having a passage for advancing the injected air to the nozzle. Preferably, an adiabatic member 540 is filled between the outside of the blastpipe 520 and the body 511 of the housing 510 in order to isolate the heat in the housing.

The heating body 530 is connected in the inside of the blastpipe 520, and its one end is supported by the closing body 513 to be heated by electric power from the outside.

In here, a heating line 531 in the heating body 530 may be wound as a coil-type to form a coil-type heating body, and may be made as a ceramic rod to form a ceramic heating body. The heating body type is selected as a need.

The preferred structure for the coil type heating body is such that, as shown in FIG. 15, the heating line 531 is bent to have 3 and more angles (4 angles in Fig.). The coil is shown as a twisted.

That is, the winding shape of a subsequent bent heating line 531 is rotated by a predetermined angle comparing with the winding shape of just preceding bent heating line to be shown as a twisted shape.

Such shaped coil type heating body increases the temperature of air by increasing points in contact with the air from the closing body 513.

Further, the heater is slightly inclined to discharge a heated air downwardly and to more easily remove the peeled-off outer cover through the exhaust pipe 12.

### FURTHER EMBODIMENT 2

FIG. 17 is a cross-sectional view of further embodiment 2 according to the present invention. In fig., a sleeve welding part is installed in front of the heater, which is for installing a shrinking sleeve in order to protect a welded point and to weld the shrinking sleeve to the welded point after performing a welding process of optical fibers.

Referring Fig, a sleeve welding part 600 is structured such that a passage 600 for a heated air from the heater 22 is formed on the base 10 in front of the heater 22, and a heating room is formed in the passage 610.

The heating room 620 has a door 630 for opening/closing the heating room 620 in order to insert an optical fiber with a shrinking sleeve S in the room. The shrinking sleeve S inserted in the heating room 620 is welded to the optical fiber by a heated air from the heater 22, the heated air also peeling off an outer cover of the optical fiber.

With such structure, the welding time of the sleeve by the heated air is effectively shortened comparing with a welding by a conventional heater. If a sleeve heater 22 is further installed in the heating room 620, the welding time is further shortened to increase efficiency.

In here, in addition to the heater for peeling off the outer cover of the optical fiber, a heated air discharging heater connected to the heating room 620 is provided to perform the welding of the sleeve S.

Further, with different from the above described structure, if the heated air is not used for welding the sleeve and the heating room 620 on the base 10 has a sleeve heater 640 therein, a conventional sleeve welding apparatus and the sleeve welding apparatus according to the present invention are operated simultaneously to increase efficiency for the welding of sleeve S two times or more.

### FURTHER EMBODIMENT 3

FIG. 18 is a circuit block diagram of further embodiment according to the present invention. This circuit is more detailed and advanced comparing with the control panel in the foregoing embodiments.

Referring figure, a control panel 700 according to the further embodiment 3 comprises a key pad 710, a thermistor 720 for sensing temperature, a microprocessor as control part, and a driver 740.

The key pad 710 is structured to have a key board for turning on/off electronic power and inputting a set-up heating temperature and so forth, and a predetermined button on the base 10. The thermistor 720 is for sensing temperature in a space heated by the heater 22 or the sleeve heater 640 in the further embodiment 2, and installed on a side of the space.

The microprocessor 730 receives the temperature signal sensed by the thermistor 720 in real time, and controls the heater or the sleeve heater when a difference between the sensed temperature and the set up temperature. The driver 740 receives a signal from the microprocessor 730 to drive the heater 22 or the sleeve heater 640.

In here, the microprocessor 730 has a data part 750 for storing a temperature data for an outer cover of optical fiber and a shrinking sleeve S in order to drive the heater 22 or the sleeve heater 640 based on working temperature according to the kind of outer cover of the optical fiber or the shrinking sleeve S.

Further, the microprocessor 730 comprises a display means 760 such as a LCD, a monitor or 7-segments to display the controlled temperature and the set up temperature.

The driver 740 can drive the cutting lever by means of a motor 770 in order to move the cutter 490 used in other embodiment. At this moment, the motor 770 is controlled by a control signal from the microprocessor 730.

### FURTHER EMBODIMENT 4

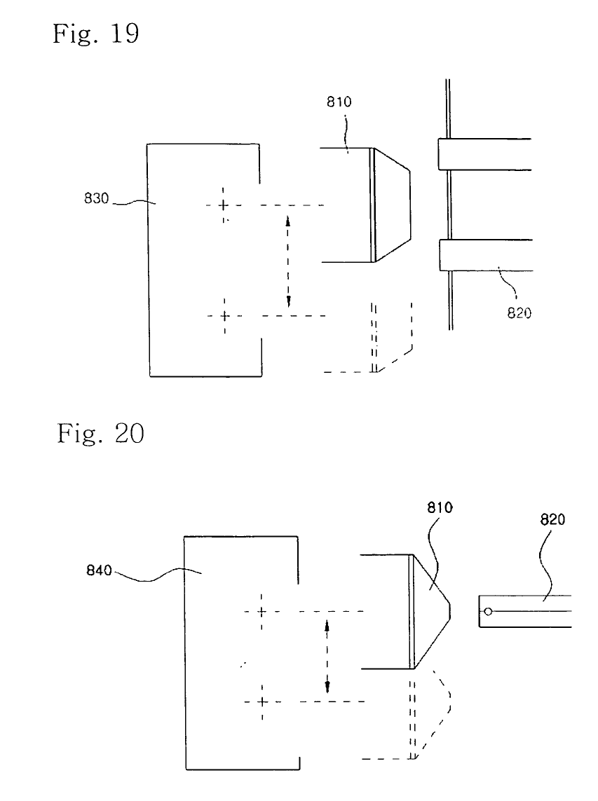

FIGS. 19 and 20 are conceptual views of the further embodiment according to the present invention.

Referring figures, in the optical fiber treatment apparatus of the further embodiment 4, a heated air discharging section of a heater 810 for discharging a heated air and a removing outer cover section of a clamped optical fiber by using a clamp 820 are opposed in a moment to remove an outer cover of an optical fiber.

The heater 810 and a driving part 830 connected on the base 10 in order to move the heater 810 straight as shown in FIG. 14a, or to move the heater vertically as shown in FIG. 14b.

In here, the driving part 830 is a motor or a cylinder to mover or to rotate the heater 810.

### FURTHER EMBODIMENT 5

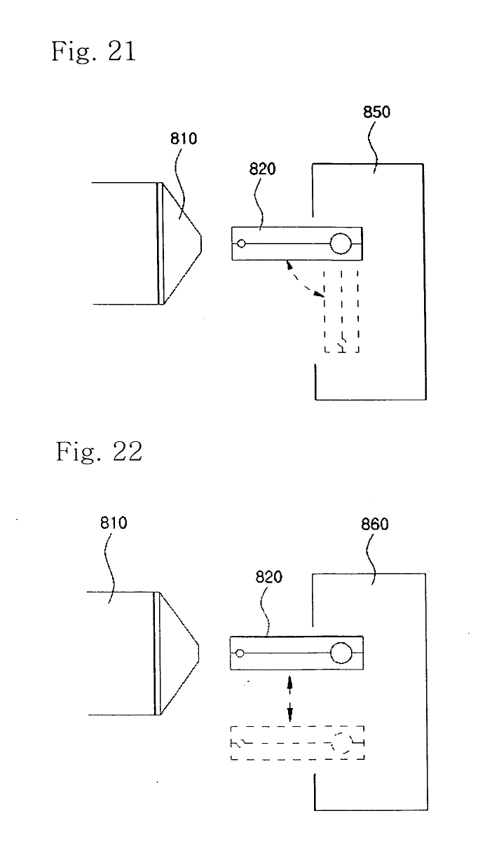

FIGS. 21 and 22 are conceptual views of further embodiment 5 according to the present invention.

Referring figures, in the optical fiber treatment apparatus of the further embodiment 5, a heated air discharging section of a heater 810 for discharging a heated air and a removing outer cover section of a clamped optical fiber by using a clamp 820 are opposed in a moment to remove an outer cover of an optical fiber. Different from the further embodiment 4, however, the optical fiber is moved straight or rotated.

A driving part 840 for moving straight or rotating the clamp 820 clamping the optical fiber is installed on the base in order to move straight or to rotate the optical fiber.

In here, the driving part 840 is a motor or a cylinder to mover or to rotate the clamp 820.

### FURTHER EMBODIMENT 6

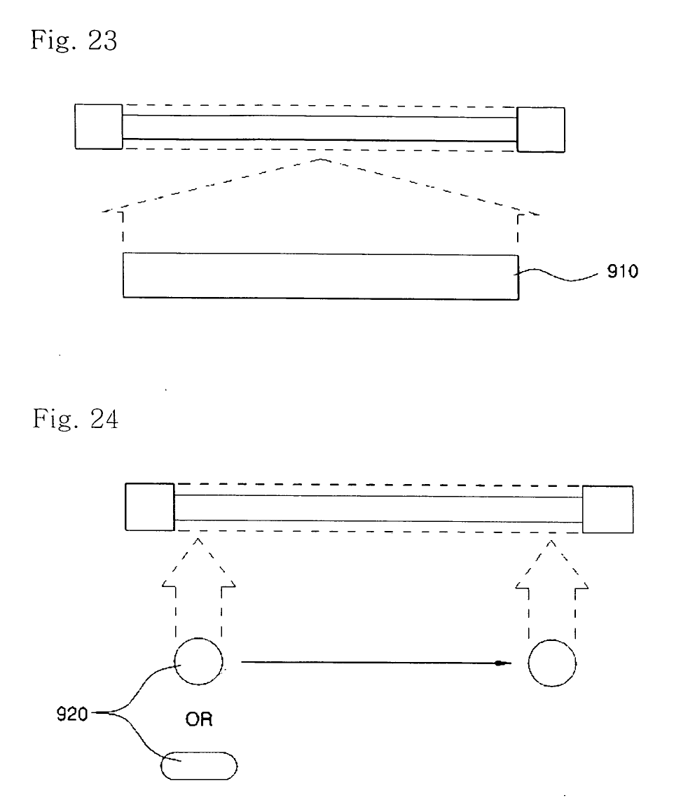

FIGS. 23 and 24 are conceptual views of further embodiment 6 according to the present invention.

Referring figures, in the optical fiber treatment apparatus of the further embodiment 6, a correlation between the length of an outer cover removing section and the length of a heated air discharging section is proposed.

In FIG. 23, the length of a heated air discharging hole 910 as the heated air discharging section is equal to the length of the outer cover removing section for the optical fiber to peel off an outer cover of optical fiber in a process for opposing the hole 910 to the outer cover removing section.

Further, in FIG. 24, the length of a heated air discharging hole 920 as the heated air discharging section is shorter than that of the outer cover removing section for the optical fiber to peel off an outer cover of optical fiber by moving the hole 920 along the outer cover removing section, or moving the optical fiber with respect to the hole 920 by the outer cover removing section.

In here, a driving part for opposing the heater to the optical fiber is the same as that of other embodiment and the further embodiments 4 and 5.

### FURTHER EMBODIMENT 7

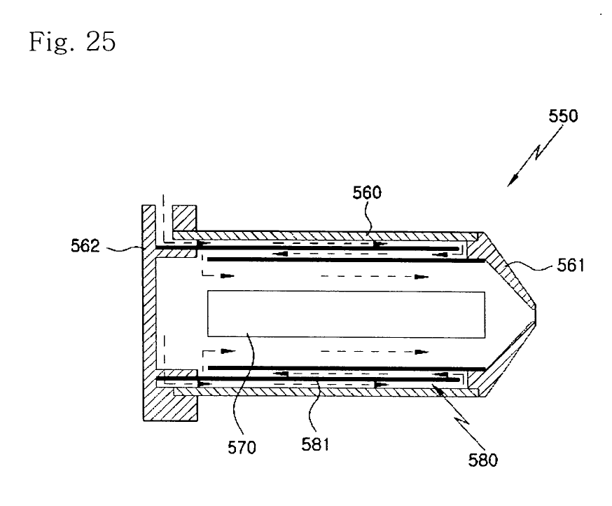

FIG. 25 is a cross-sectional view of further embodiment 7 according to the present invention.

Referring figure, a heater 550 different from that of the further embodiment 1 is provided in the further embodiment 7.

The heater 550 comprises a housing 560, a heating body 570, and a passage forming pipe 580.

In the housing 560, a nozzle 561 for discharging air is connected to one end of a hollow body and a closing body 562 for closing the body is connected to the other end of the body. The heating body 570 is connected in the housing 560 to heat through electric power from an outside power supply, and is a coil type heating body for a ceramic heater for heating an injected air.

The passage forming pipe 580 is structured such that numbers of pipes 581 (3 in figure, thus 2 passages formed) having different diameters are connected in closing body 562 and the nozzle 561 to go and return the air injected through the closing body 562 two times and more from the inner circumference of the housing to the heating body between the housing 560 and the heating body 570.

In the heater 550, numbers of air passages are formed between the heating body 570 and the outside of passage in contact with air to prevent the hot air heated by the air from being discharged outside.

With such structure, the heat loss of the heated air for welding the outer cover of optical fiber or the sleeve in the further embodiment 2 is minimized to increase efficiency.

As described above, as all the processes for peeling-off of the optical fiber, cleaning and cutting, and a process for welding of a sleeve performed by a separate apparatus in past can be performed in one apparatus, the apparatus according to the present invention increases operation efficiency and saves working hours comparing with a conventional apparatus.

Further, in the present invention, the increasing of temperature of the heater can be gradually controlled by the control panel. Thus, the problem caused by the physical property difference of the outer cover, the daily range, the seasonal temperature difference and the humidity difference can be solved by controlling the temperature.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. An optical fiber treatment apparatus for peeling off an outer cover of an optical fiber having an inside outer cover and an outside outer cover, the apparatus comprising:
a base; and
an outer cover peeling-off part, said outer cover peeling-off part holding the optical fiber with straight, and discharging a heated air to the straight held optical to remove the outer cover of the optical fiber by using a difference of thermal deformation between the inside outer cover and the outside outer cover.

2. An optical fiber treatment apparatus as claimed in claim 1, wherein a temperature of the heated air is set to 400° C.˜500° C.

3. An optical fiber treatment apparatus as claimed in claim 1, wherein the outer cover peeling-off part includes:
a heater, installed on the base, for heating air injected from outside to discharge the heated air to the outside; and
a clamp means, installed on the base, for clamping both side of the optical fiber at a point for the heated air discharged by the heater to remove the outer cover by means of the heated air from the heater.

4. An optical fiber treatment apparatus as claimed in claim 3, wherein the heater includes:
a housing having a hollow body, one end of the hollow body connected to a nozzle for discharging air, and the other end of the hollow body connected with a closing body for closing the hollow body;
a blastpipe connected in the housing and having a passage for passing air injected through the closing body to the nozzle; and
a heating body installed in the blastpipe, said heating body being heated by electric power from outside to heat the injected air.

5. An optical fiber treatment apparatus as claimed in claim 4, wherein said heating body is any one of a coil type heating body formed by winding a heating line as a coil-shape and a ceramic heating body formed as a ceramic rod.

6. An optical fiber treatment apparatus as claimed in claim 5, wherein said coil type heating body is formed by bending the heating line to have 3 and more angles, said heating body being shown as a twisted shape.

7. An optical fiber treatment apparatus as claimed in claim 3, wherein the clamp means further includes a sliding guide, said sliding guide having a straight line in front of the heated air discharging opening of the heater.

8. An optical fiber treatment apparatus as claimed in claim 3, wherein the clamp means comprises:
a clamp bundle connected on an axis of the sliding guide to perform selectively a straight movement and a rotational movement;
a finger base having a receiving groove for positioning the optical fiber on the lower side of the clamp bundle;
a finger connected by a hinge and for clamping the optical fiber in the receiving groove on the upper side of the finger base;
a torsion spring elastically connected the hinge to apply always elasticity in a direction for unclamping the finger; and
a finger operating lever rotatably connected the finger base in the rear of the finger to clamp the finger through a rotation operation.

9. An optical fiber treatment apparatus as claimed in claim 8, wherein the clamp means further comprises:
a rotation preventing axis for connecting the clamp bundles to prevent an individual movement of clamp bundle.

10. An optical fiber treatment apparatus as claimed in claim 7, wherein the clamp means further comprises:
a tension controlling means for adjusting a tension of the clamped optical fiber by moving the tension controlling means centering around an axis of an fixing axis by a clearance in the equally divided clamp bundles.

11. An optical fiber treatment apparatus as claimed in claim 10, wherein the tension controlling means comprises:
a ball bearing positioned with a point contact between the outer diameter of the fixing axis and the inner diameter of the clamp bundles to guide a rotational movement, or the rotational movement and a straight movement;
a big diameter and a small diameter ring bushes connected slidably with each other and positioned between the inner diameter of each one end of the clamp bundles and the outer diameter of the fixing axis with a slack;
a elastic member elastically connected in the inner side of each of the clamp bundles between the ring bushes to push the clamp bundles at all times;
a tension applying pusher coupled slidably on the fixing axis from a tip end of the fixing axis to a tip end of the clamp bundle; and
a cam lever rotatably connected to an end of the fixing axis, and having a curved cam line to move the tension applying pusher with a predetermined clearance according to a rotation of the fixing axis and to supply an operational power to the elastic member.

12. An optical fiber treatment apparatus as claimed in claim 1, further comprising a cutting means, positioned on the base at a side of the outer cover peeling-off part, for clamping the optical fiber and for cutting the clamed optical fiber.

13. An optical fiber treatment apparatus as claimed in claim 12, wherein the cutting means comprises:
a body having a straight guiding groove perpendicular to the sliding guide and installed on a side of base 10, the side being not faced to the heater and included in a straight section of the clamp means;
a slider connected in the straight guiding groove of the body;
a slider controlling means provided to both of the body and the slider to control a forward and backward movement of the slier to make it possible to scratch the optical fiber when the clamp means in a cutting position, and to maintain the backward movement of the slider for cutting the optical fiber;
a cutter, mounted on the slider having the slider controlling means, for scratching a circumference of the optical fiber along a movement of the slider;
a press means operated in the direction of rotating axis on the optical fiber scratched by the cutter to cut the scratched portion of the optical fiber; and
a cover rotatably connected to a side of the body and pivoted on the hinge to control the forward and backward movement of the slider, and to control the rise and fall of the press means in connection with the forward and backward movement of the slider.

14. An optical fiber treatment apparatus as claimed in claim 13, wherein the slider controlling means comprises:
an elastic member positioned between the slider and the straight guiding groove to provide a forward force to the slider;
a pusher formed at the rear of the cover to operate in connection with an opening of the cover, and to overcome elasticity of the elastic member to back the slider;
a lower stopper elastically supported by a elastic member in vertical direction on the slider to obtain a climbing power in order to maintain the slider backed by the pusher or to move the slider forward;
an upper stopper, operated in connection with a closing motion of the cover, for controlling the lower stopper to provide a forward force to the slider; and
a protrusion, formed on a side of the slider, for falling the press means after the optical fiber being scratched by on operation of the lower and upper stoppers together with the forward movement of the slider.

15. An optical fiber treatment apparatus as claimed in claim 13, wherein the press means comprises:
a plunger positioned under the cover opposite to the cutter moved forward and backward, and risen and fallen by an elastic member; and
a plunger stopper protruded downwardly from a side of the plunger and supported by the protrusion of the slider, the plunger stopper stroking and cutting a scratched portion of the optical fiber as a supporting of the protrusion being released after the optical fiber scratched by a forward movement of the slider and the cutter.

16. An optical fiber treatment apparatus as claimed in claim 12, wherein the cutting means is an ultrasonic cutter, and the ultra sonic cutter cuts an optical fiber with a removed outer cover when the optical fiber with the outer cover removed by the outer cover peeling-off part is mounted.

17. An optical fiber treatment apparatus as claimed in claim 16, wherein the ultrasonic cutter comprises:
a body mounted on the base to be straight to the clamp means, the body having a slidably connected guide axis, the guide axis being moved in straight in paralled to a length direction of the clamped optical fiber;
a sliding body slidably connected to move forward and backward with respect to the clamped optical fiber on the upper part of the body, and having a stopper for limiting the forward and backward movement to the body in the rear;
a damper installed at the rear of the body to interfere with the stopper at all times, and providing a reduced forward moving force to the sliding body through a spring pushing the sliding body and a piston generating an air resistance;
a cutting lever rotated by a rotating axis at the front of the body, and providing a reduced backward moving force to the sliding body by overcoming the damper by means of an interfering protrusion projected from the sliding body in a rotating position; and
a cutter installed on the upper part of the sliding body to be operated with the operation of the damper and the cutting lever, and cutting the optical fiber by using a vibration from an ultrasonic oscillator.

18. An optical fiber treatment apparatus as claimed in claim 12, wherein further comprising an exhaust pipe, in the base, for removing and discharging a smoke or a stench produced by the peeling-off of the outer cover from the heater, and an exhaust fan connected to the exhaust pipe.

19. An optical fiber treatment apparatus as claimed in claim 12, wherein a sleeve welding part for inserting a sleeve in an optical fiber and welding the sleeve is installed on the base, the optical fiber being performed with a peeling-off of outer cover, a cutting by a cutter and a welding by a separate welder.

20. An optical fiber treatment apparatus as claimed in claim 19, wherein the sleeve welding part comprises a heating room connected to a passage for a heated air, and a door for opening/closing the heating room when an optical fiber with a shrinking sleeve being positioned in the heating room.

21. An optical fiber treatment apparatus as claimed in claim 20, wherein the sleeve welding part further comprises a sleeve heater in the heating room to shorten the heating time of the shrinking sleeve.

22. An optical fiber treatment apparatus as claimed in claim 19, wherein a sleeve welding part comprises a heating room with a door for opening/closing the inner space of the room in the base, and a sleeve heater for heating an optical fiber with a shrinking sleeve in the inner space and welding the sleeve.

23. An optical fiber treatment apparatus as claimed in claim 19, wherein the sleeve welding part comprises another heater for peeling off the outer cover in addition to the heater for discharging a heated air, a heating room connected to a section for discharging the air heated by the another heater, and a door for opening/closing the heating room when an optical fiber with a shrinking sleeve being positioned in the heating room.

24. An optical fiber treatment apparatus as claimed in claim 12, wherein further comprising a control panel for turning on/off electric power, controlling a heating temperature gradually, and controlling processes for peeling-off of outer cover, cutting and sleeve welding.

25. An optical fiber treatment apparatus as claimed in claim 24, wherein the control panel comprises:
a key pad for inputting requirements for turning on/off electric power, setting of heating temperature and processes for peeling-off of outer cover and welding of cut sleeve;
a temperature sensing part, installed on a side of a space, for sensing air heated by heater or the sleeve heater in the space;
a control part for receiving the temperature signal sensed by the temperature sensing part in real time, and controlling an operation of the heater or the sleeve heater and an operation of a driver for moving a cutting means when a difference between the sensed temperature and the set up temperature being sensed; and
the driver for driving the cutting means for moving the heater, the sleeve heater and the cutting means through a signal from the control part.

26. An optical fiber treatment apparatus as claimed in claim 25, wherein the control part comprises a data part for storing a temperature data for the outer cover of optical fiber and the shrinking sleeve in order to drive the heater or the sleeve heater based on working temperature according to the kind of outer cover of the optical fiber or the shrinking sleeve.

27. An optical fiber treatment apparatus as claimed in claim 12, wherein the heater is slightly inclined to discharge the heated air downwardly.

28. An optical fiber treatment apparatus as claimed in claim 12, wherein further comprising a driving part for moving the heater horizontally or vertically in other to oppose a heated air discharging section to an outer cover removing section in a moment to remove the outer cover.

29. An optical fiber treatment apparatus as claimed in claim 12, wherein further comprising a driving part, in the base, for moving an optical fiber with straight or rotating the optical fiber in order to oppose a heated air discharging section to an outer cover removing section in a moment to remove the outer cover.

30. An optical fiber treatment apparatus as claimed in claim 12, wherein a length of a heated air discharging section is formed to be equal to that of an outer cover removing section to peel of an outer cover of optical fiber in a process for opposing the heated air discharging section to the outer cover remove section.

31. An optical fiber treatment apparatus as claimed in claim 12, wherein a heated air discharging section is formed to shortened than that of an outer cover removing section to peel off an outer cover of optical fiber by moving the heated air heated air discharging section along the outer cover removing section, or moving the optical fiber with respect to the heated air discharging section by the outer cover removing section.

32. An optical fiber treatment apparatus as claimed in claim 3, wherein the heater comprises:
a heater, installed on the base, for heating air injected from outside to discharge the heated air to the outside;
a heating body connected in the housing to heat an injected air though electric power from an outside power form an supply; and
a passage forming pipe connected between the housing and the heating body to go and return air injected though a closing body from the inner circumference of the housing and the heating body two time and more, and to discharge the air to the nozzle.
